(19) United States
(12) Patent Application Publication
(10) Pub. No.: US 2007/0270532 A1
(43) Pub. Date: Nov. 22, 2007

(54) Polyvinyl Chloride Fiber and Process for Production Thereof

(75) Inventors: Yasuo Ishibashi, Shiga (JP); Toshihiko Hirose, Shiga (JP); Hiroshi Yokoyama, Hyogo (JP)

Correspondence Address: HAMRE, SCHUMANN, MUELLER & LARSON, P.C., P.O. BOX 2902, MINNEAPOLIS, MN, 55402-0902, US

(73) Assignee: KANEKA CORPORATION, OSAKA-SHI (JP)

(21) Appl. No.: 11/663,472

(22) PCT Filed: Sep. 29, 2005
(86) PCT No.: PCT/JP05/17934

§ 371 Date: Mar. 22, 2007

(30) Foreign Application Priority Data
Sep. 30, 2004 (JP) 2004-289320

(51) Int. Cl. D01F 6/48; C08K 3/26; C08K 5/07; C08K 5/098; C08L 27/06; D01D 5/084

(52) U.S. Cl. 524/296; 264/211.12; 524/284; 524/436

(57) ABSTRACT

The polyvinyl chloride-based fiber of the present invention is formed of a vinyl chloride-based resin composition obtained by blending, with respect to (a) 100 parts by weight of a vinyl chloride-based resin, (b) 0.1 parts by weight to 0.6 parts by weight of a hydrotalcite-based thermostabilizer, (c) 0.1 parts by weight to 0.5 parts by weight of β-diketone, (d) 0.2 parts by weight to 0.5 parts by weight of a calcium soap and a zinc soap, (e) 0.7 parts by weight to 1.7 parts by weight of a lubricant, and (f) 0.5 parts by weight to 5 parts by weight of a plasticizer. Thereby, the present invention provides a polyvinyl chloride-based fiber that has an excellent touch feeling as a fiber for hair, excellent transparency and a vivid color tone, and can be obtained by stable melt spinning with less occurrence of filament breakage.

### TECHNICAL FIELD

The present invention relates to a polyvinyl chloride-based fiber that has excellent transparency and spinning stability with less generation of a deteriorated resin and less occurrence of filament breakage, and a method for manufacturing the fiber by melt spinning. The polyvinyl chloride-based fiber can be used for artificial hair for hair adornment such as wigs, hairpieces and braids, and artificial hair such as doll hair.

### BACKGROUND ART

A vinyl chloride-based resin has an excellent self-extinguishing property, chemical resistance and the like, and in the case of being processed into a fiber, the excellent properties can be achieved. Conventionally, in the case of industrially manufacturing a fiber with small fineness (a fine fiber with a small cross-sectional area) as a fiber for artificial hair for hair adornment or the like, a wet spinning method using a solvent with respect to a vinyl chloride-based resin or a dry spinning method commonly is used. However, these methods require a desolvating process because of using a solvent, and require an excessively large capital investment, whereby much manpower is necessary for the maintenance of the capital. Moreover, since a comonomer such as acrylonitrile and vinyl acetate is copolymerized in order to increase a solubility with respect to the solvent, a color of the fiber is likely to be strong yellow in a drying step due to a problem in initial colorability of the fiber, or curl retention is not sufficient because a softening temperature of the fiber is decreased.

Whereas, as a spinning method in which a solvent is not used is known, a melt spinning method is known, however, in this method, addition of a thermostabilizer and a lubricant is necessary for preventing thermal decomposition of a vinyl chloride-based resin. In order to prevent thermal decomposition and secure a long-running property, it is advantageous to set a melt spinning temperature to be low. Also, in order to obtain a dry touch feel of a vinyl chloride-based fiber for human hair, it is not preferable to increase the melt spinning temperature, which smoothes a surface of the fiber. However, if setting the melt spinning temperature to be low, a melt viscosity of the vinyl chloride-based resin composition is increased, and a pressure on a nozzle is increased, whereby a problem of exceeding a designed pressure of an extruder is likely to occur.

Thus, in order to solve these problems, a Cd—Pb-based thermostabilizer and a lubricant are used as a conventional technique for decreasing an apparent melt viscosity of the composition. However, these compounding agents have high toxicity, and have a problem in hygienic safety in manufacturing and because they are in contact with skins directly for hair adornment. Moreover, when discarding such hair adornment tools and the like, they may be mixed into municipal wastes and contaminate the environment.

Then, in order to solve the problems of the blend system mainly including the Cd—Pb-based thermostabilizer, it is switched to use a tin-based thermostabilizer, a hydrotalcite-based thermostabilizer or a Ca—Zn-based thermostabilizer alone or in combination. And, Patent document 1 suggests a decrease of the apparent melt viscosity of the vinyl chloride-based resin composition, and adding a plasticizer or a low molecular-weight vinyl chloride-based resin for decreasing a pressure on the extruder.

Patent document 2 refers to a polyvinyl chloride-based fiber in which, with respect to 100 parts by weight of vinyl chloride, 0.8 parts by weight to 3 parts by weight of a hydrotalcite-based thermostabilizer, 0.25 parts by weight to 2 parts by weight of a calcium soap and a zinc soap, and 0.1 parts by weight to 0.4 parts by weight of β-diketone are blended. Moreover, in Patent document 3, the composition described Patent document 2 having a blend of 0.5 parts by weight to 2 parts by weight of an epoxidized plasticizer is added and 1 part of the metallic soap is replaced with 0.2 parts by weight to 1 part by weight of a lubricant is used. However, in the vinyl chloride-based fiber described in the above-stated documents, a deteriorated resin is generated at the time of the spinning and the transparency of the filament that is subjected to the melt spinning deteriorates, because of the large added amount of the hydrotalcite-based thermostabilizer ranging from 0.8 parts by weight to 3 parts by weight.

Patent document 1: JP 11(1999)-61555 A

Patent document 2: JP 2001-98413 A

Patent document 3: JP 2001-98414 A

### DISCLOSURE OF INVENTION

### Problem to be Solved by the Invention

A tin-based stabilizer has good compatibility with a vinyl chloride-based resin, and thus promotes gelation excessively, which degrades metal releasability of the whole of a melt of the vinyl chloride-based resin composition extremely. In order to prevent this degradation, adding of a large amount of lubricant is required, and when the vinyl chloride-based resin composition to which the large amount of the lubricant is added is subjected to the melt spinning from a nozzle with a small hole diameter, a deteriorated resin (which is obtained by carbonizing a deposit such as an additive component) is likely to be generated on a peripheral portion of the nozzle hole, thereby being likely to cause filament breakage, which is a new problem. Moreover, such tin-based thermostabilizers are organic tin compounds and thus have various unique odors, and their use is sometimes avoided because they generate odors when processing the fibers into products for hair adornment by heat.

Each of the above-described Patent documents 2 and 3 uses a hydrotalcite-based thermostabilizer of an inorganic compound. Thus, it has no problem of the generation of odor like that of the tin-based thermostabilizer, and the generation of a deteriorated resin and the like caused by the addition of the large amount of the lubricant is improved. However, since the added amount of the hydrotalcite-based thermostabilizer is large and ranges from 0.8 parts by weight to 3 parts by weight, the generation of the deteriorated resin on the peripheral portion of the nozzle hole and the filament breakage at the time of the melt spinning do not exhibit satisfactory levels. Moreover, it degrades the transparency of the filament that is subjected to the melt spinning, and improvement is necessary in order to obtain the vinyl chloride-based resin having a vivid color tone.

### Means for Solving Problem

As a result of the keen study by the present inventors in order to solve the above-described problems, they found that the vinyl chloride-based fiber having excellent transparency and a vivid color tone is obtained by stable melt spinning with less generation of the deteriorated resin and less occurrence of the filament breakage, even in the case of using small amounts of hydrotalcite, a calcium soap and a zinc soap as a thermostabilizer when the vinyl chloride-based resin composition is subjected to the melt spinning, thereby reaching the completion of the present invention.

In other words, the present invention relates to a polyvinyl chloride-based fiber that is formed of a vinyl chloride-based resin composition obtained by blending, with respect to (a) 100 parts by weight of a vinyl chloride-based resin, (b) 0.1 parts by weight to 0.6 parts by weight of a hydrotalcite-based thermostabilizer, (c) 0.1 parts by weight to 0.5 parts by weight of β-diketone, (d) 0.2 parts by weight to 0.5 parts by weight of a calcium soap and a zinc soap, (e) 0.7 parts by weight to 1.7 parts by weight of a lubricant, and (f) 0.5 parts by weight to 5 parts by weight of a plasticizer.

Moreover, the method for manufacturing a polyvinyl chloride-based fiber of the present invention is characterized in that, when the vinyl chloride-based resin composition is subjected to melt spinning, the vinyl chloride-based resin composition is subjected to the melt spinning from nozzle holes each of which has a cross-sectional area of 0.5 mm² or less, an undrawn filament of 300 dtexes or less is manufactured, and subsequently the undrawn filament is subjected to drawing treatment and heat treatment so as to process into a fiber of 100 dtexes or less.

### Effects of the Invention

With the polyvinyl chloride-based fiber of the present invention, a fiber for artificial hair that has an excellent touch feeling as a fiber for hair, excellent transparency and a vivid color tone can be obtained by stable melt spinning with less generation of a deteriorated resin and less filament breakage occurring in its manufacturing process. Thus, the productivity is high and the manufacturing cost can be reduced. The polyvinyl chloride-based fiber also can be applied to the field of industrial materials and the like other than artificial hair, such as brushes and the like.

### DESCRIPTION OF THE INVENTION

The hydrotalcite-based stabilizer that is a stabilizer for vinyl chloride according to the present invention can maintain a significantly stable state at a high temperature, but may cause dispersal disorder at the time of melt extrusion and cause filament breakage and fusion due to a screen clog if the blending amount is too large. Also in Patent document 1, since hydrotalcite itself becomes an aggregate and a frequency of the filament breakage is increased, it is preferable to use 0.8 parts by weight to 3 parts by weight of the hydrotalcite with respect to 100 parts by weight of polyvinyl chloride. However, it is realized that, in order to increase the transparency of the spinned fiber, the hydrotalcite-based stabilizer should be suppressed to be less than 0.8 parts by weight. In view of the coloration of the spinned filament, and the occurrence of the filament breakage and the generation of the deteriorated resin, it is recognized that, from the experiments, a range of the hydrotalcite-based stabilizer is from 0.1 parts by weight to 0.6 parts by weight, and in particular, the more preferable range is from 0.2 parts by weight to 0.5 parts by weight, which can stabilize the melt spinnability.

As a method for decreasing the initial coloration of the filament that is subjected to the melt spinning, it is preferable to add 0.1 parts by weight to 0.5 parts by weight of β-diketone, and it is more preferable to add 0.2 parts by weight to 0.4 parts by weight thereof. Most preferably, 0.2 parts by weight of stearylbenzoylmethane (SBM) and 0.2 parts by weight of dibenzoylmethane (DBM) are added. As the metallic soap, 0.2 parts by weight to 0.5 parts by weight of a calcium soap and a zinc soap is preferably used, but the calcium soap and the zinc soap are higher fatty acids and/or their derivatives, and most preferably, 0.1 parts by weight of the calcium soap and 0.2 parts by weight of the zinc soap are used in combination. 0.7 parts by weight to 1.7 parts by weight of the lubricant preferably is added, and at least one kind is selected from the group consisting of a polyethylene-based lubricant, a higher fatty acid-based lubricant, an ester-based lubricant and a higher alcohol-based lubricant. More preferably, 0.7 parts by weight to 1.3 parts by weight thereof is added. 0.5 parts by weight to 5 parts by weight of the plasticizer is added, but at least one kind is selected from the group consisting of a phthalate-based plasticizer; a trimellitate-based plasticizer; a pyromellitate-based plasticizer; a polyester-based plasticizer; and an epoxy-based plasticizer. More preferably, 1.0 part by weight to 4.0 parts by weight thereof is added, thereby suppressing a pressure and resin heating at the time of the spinning.

When the vinyl chloride-based resin composition is subjected to the melt spinning, it can be melted and flows out from the nozzle holes, each of which has a cross-sectional area of 0.5 mm² or less. Moreover, at the time of the melt spinning, it also is possible to melt and flow out from the nozzle holes each of which has a cross-sectional area of 0.5 mm² or less, manufacture an undrawn filament of 300 dtexes or less, and subsequently carry out drawing treatment and heat treatment with respect to this undrawn filament, thereby processing it into a fiber of 100 dtexes or less.

By using the vinyl chloride-based resin composition of the present invention, a vinyl chloride-based resin fiber that has a touch feeling that is extremely similar to human hair, excellent transparency and a vivid color tone can be manufactured from the nozzle holes each of which has a cross-sectional area of 0.5 mm² or less, while a resin temperature at the time of the melt spinning is a comparatively low at 195° C. or less, and the nozzle pressure is a setting pressure of the extruder at 500 kg/cm² or less.

The present invention will be described below in detail. The vinyl chloride-based resin that is a component (a) of the present invention is composed of a homopolymer resin that is a conventionally known homopolymer of vinyl chloride or conventionally known various kinds of copolymer resins, and is not limited particularly. Representative examples of the copolymer resin include: a copolymer resin of vinyl chloride and vinyl ester such as a vinyl chloride-vinyl acetate copolymer resin and a vinyl chloride-vinyl propionate copolymer resin; a copolymer resin of vinyl chloride and acrylic ester such as vinyl chloride-butyl acrylate copolymer resin and a vinyl chloride-2-ethylhexyl acrylate copolymer; a copolymer resin of vinyl chloride and olefin such as a vinyl chloride-ethylene copolymer resin and a vinyl chloride-propylene copolymer resin; a vinyl chloride-acrylonitrile copolymer resin; and the like. Particularly preferably, a vinyl chloride resin, a vinyl chloride-ethylene copolymer resin and a vinyl chloride-vinyl acetate copolymer resin are used.

In the copolymer resin, a content of the comonomer to be combined with vinyl chloride is not limited particularly, and can be determined according to a required property such as melt extrusion processibility and a filament property. In particular, the content of the comonomer preferably ranges from 2 wt % to 30 wt %.

A viscosity average degree of polymerization of the vinyl chloride-based resin used in the present invention preferably ranges from 850 to 1700. If the viscosity average degree of polymerization of the vinyl chloride-based resin is less than 850, properties of the fiber, in particular, the curl retention and the like are likely to be insufficient, thus being not preferable. On the other hand, if the viscosity average degree of polymerization is more than 1700, the melt viscosity is increased, and the nozzle pressure is increased, which results in the necessity of suppressing the extruding amount to be small, thus being not preferable. From the balance between the melt extrusion processibility and the fiber properties, in the case of using the vinyl chloride resin, the viscosity average degree of polymerization particularly preferably ranges from 850 to 1450, and in the case of using the copolymer, the viscosity average degree of polymerization particularly preferably ranges from about 1000 to about 1700, which depends on the content of the comonomer.

Moreover, as the vinyl chloride-based resin, a vinyl chloride-based resin that is manufactured by emulsion polymerization, block polymerization, suspension polymerization or the like may be used, but it is preferable to use a vinyl chloride-based resin that is manufactured by suspension polymerization, considering the initial colorability of the fiber and the like.

The hydrotalcite-based thermostabilizer that is a component (b) of the present invention is an anion exchangeable layered compound that contains magnesium-aluminum-hydroxide-carbonate-hydrate in chemical name that is represented by a general formula (I) as a main component.
MgₓAl₂(OH)₍₂₊₄₎CO₃nH₂O] (1)

It exhibits a HCl-trapping effect so as to function as a thermostabilizer. As disclosed in JP 4(1992)-73457 B, a hydrotalcite-based thermostabilizer in which a part of magnesium is substituted by Ca or Zn, or hydrotalcite-based thermostabilizers that are processed with various kinds of surface treating agents also may be used. Examples of the hydrotalcite-based thermostabilizer that is commercially available in the market include “ALCAMIZER” as product name produced by Kyowa Chemical Industry Co., Ltd. An added amount of the hydrotalcite-based thermostabilizer preferably ranges from 0.1 parts by weight to 0.6 parts by weight. If the added amount is too large, the generation of a deteriorated resin and the occurrence of filament breakage is increased, and nozzle ejection of the multifilament becomes nonuniform. And, transparency of the spinned fiber is decreased, and a color tone becomes less sharp. If the added amount is too small, the thermostability becomes insufficient, and the initial coloration of the spinned fiber is increased, and resin burning is likely to occur if there is a resin retention portion. Thus, the more preferable added amount ranges from 0.2 parts by weight to 0.5 parts by weight.

Patent document 4: JP 4(1992)-73457 B

β-diketone that is a component (c) of the present invention exhibits a superior initial coloration preventing effect when being used with a metallic soap, in particular, a Zn salt. Representative examples thereof include: acetylacetone; benzoylacetone; stearoylbenzoylmethane (SBM); dibenzoylmethane (DBM); ethyl acetoacetate; and dehydroacetic acid. An added amount thereof preferably ranges from 0.1 parts by weight to 0.5 parts by weight, and if the added amount is more than 0.5 parts by weight, the generation of a deteriorated resin and the occurrence of filament breakage tend to be increased, which is not preferable, and if the added amount is less than 0.1 parts by weight, the initial coloration is increased, and the color tone disorder is resulted. The more preferable added amount ranges from 0.2 parts by weight to 0.4 parts by weight, and the most preferable combination is SBM and DBM.

The hydrotalcite-based thermostabilizer does not exhibit excellent dispersibility in a vinyl chloride-based resin composition. Then, a calcium soap is added to compensate this, and a zinc soap is added in combination in order to prevent the initial coloration.

As the calcium soap and the zinc soap that are a component (d) of the present invention, various kinds thereof can be used, and an added amount thereof preferably ranges from 0.2 parts by weight to 0.5 parts by weight. If the added amount is more than 0.5 parts by weight, the generation of a deteriorated resin and the occurrence of filament breakage tend to be increased, and transparency of the spinned fiber is decreased, thus being not preferable. Moreover, if the added amount is less than 0.2 parts by weight, a thermostabilizing effect is not sufficient, and the initial coloration is increased, which causes the color tone disorder. In order to obtain an uniform state of melt of the vinyl chloride-based resin composition, the calcium soap and the zinc soap are preferably a calcium salt of higher fatty acid, a zinc salt of higher fatty acid and/or a derivative thereof. Examples thereof include a calcium salt, a zinc salt or a mixture thereof with a hydroxyl (OH) derivative, such as stearic acid, lauric acid, palmitic acid, oleic acid, and/or 12-hydroxystearic acid. The most suitable combination of the metallic soaps is a combination of a calcium soap and a zinc soap.

A lubricant that is a component (e) of the present invention is a commonly used agent for the purpose of decreasing friction with a metal surface of a processing machine and decreasing frictions between the resins so as to improve the flowability and releasability thereof and improve processibility when a plastic is subjected to a molding process. Kinds of the lubricant include hydrocarbon, fatty acid, aliphatic alcohol, aliphatic amide, a metallic soap and ester. An added amount ranges from 0.7 parts by weight to 1.7 parts by weight. If the added amount is more than 1.7 parts by weight, the generation of a deteriorated resin and the occurrence of filament breakage tend to be increased, and the transparency of the spinned fiber is decreased, thus being not preferable. If the added amount is less than 0.7 parts by weight, a temperature and the coloration of the resin are increased due to an increase of the friction, and the nozzle pressure is also increased, thus being not preferable. The particularly preferable added amount of the lubricant ranges from 0.7 parts by weight to 1.3 parts by weight. A preferable kind among the lubricants is at least one kind selected from the group consisting of a polyethylene-based lubricant; a higher fatty acid-based lubricant; a higher alcohol-based lubricant; and an ester-based lubricant. As the polyethylene-based lubricant, a conventionally known polyethylene-based lubricant can be used, but it particularly is an unoxidized type or a slightly polarized type that has an average molecular weight ranging from about 1500 to about 4000 and a density ranging from 0.91 to 0.97. Specific examples of the higher fatty acid-based lubricant include: stearic acid; palmitic acid; myristic acid; lauric acid; capric acid; oleic acid; behenic acid; 12-hydroxystearic acid; and mixtures thereof. Specific examples of the higher alcohol-based lubricant include: stearyl alcohol; palmityl alcohol; myristyl alcohol; lauryl alcohol; oleyl alcohol; and mixtures of them; and the like. The ester-based lubricant is fatty ester of alcohol and polyhydric alcohol, and includes: monoester of the higher fatty acid with polyhydric alcohol such as glycerin, pentaerythritol and dipentaerythritol; diester, trimester, tetraester and mixture of them; and an ester of the higher alcohol with fatty acid. Specific examples thereof include; monoglycerite stearate; pentaerythritol tetrastearate; stearyl stearate; and the like.

As a plasticizer that is a component (f) of the present invention, a known plasticizer that can be used conventionally for a vinyl chloride resin can be used. For example, one or more kinds of plasticizers selected from a phthalate-based plasticizer, a trimellitate-based plasticizer, a pyromellitate-based plasticizer, a polyester plasticizer, an epoxy-based plasticizer, an aliphatic dibasic acid ester plasticizer, a chlorinated paraffin plasticizer and a phosphoric ester plasticizer are preferable. An added amount of the plasticizer preferably ranges from 0.5 parts by weight to 5 parts by weight with respect to 100 parts by weight of the vinyl chloride-based resin. If the added amount is less than 0.5 parts by weight, melt viscosity of the composition is high, and a pressure on the extruder and the nozzle is excessive. On the other hand, if the added amount is more than 5 parts by weight, not only a heat shrinkage ratio of the fiber is increased, but also the occurrence of a plasticizer mist tends to be significant at the time of the melt spinning, thus being not preferable. From the balance between the behavior at the time of the melt spinning and the quality of the fiber such as the heat shrinkage ratio, the more preferable plasticizers are: a phthalic acid-based plasticizer such as isononyl phthalate and undecyl phthalate; a trimellitic acid-based plasticizer such as trioctyltrimellitate; a pyromellitic acid-based plasticizer such as tetraoctylpyromellitate; an adipic acid-based polyester plasticizer; and an epoxy-based plasticizer such as an epoxidized soybean oil. In the range of the above-described added amount of the plasticizer, a range from 1.0 part by weight to 4.0 parts by weight is particularly preferable, in the light of both of facilitating the extrudablity and suppressing the heat shrinkage of the fiber.

In the present invention, other than the above, a known compounding agent that is used for a vinyl chloride-based composition, for example, a processing aid, a stabilizing aid, an ultraviolet absorber, an antioxidant, an antistatic agent, a filler, a flame retardant, a pigment or the like can be used depending on its purpose, as long as it does not degrade the property of the fiber that is subjected to the melt spinning such as its transparency and the spinning stability. Moreover, in some cases, a specific compounding agent such as a foaming agent, a cross-linking agent, a tackifier, a conductive property instilling agent and a perfume also can be used.

As the processing aid, a known processing aid can be used. For example, an acrylic processing aid containing methyl methacrylate as a main component, an EVA-based processing aid containing EVA as a component, or a polyester processing aid containing a thermoplastic polyester as a main component may be used. An amount of the processing aid to be used preferably ranges from about 0.2 parts by weight to about 12 parts by weight with respect to 100 parts by weight of the vinyl chloride-based resin. Moreover, these processing aids can be used alone or in combination of two kinds or more.

The vinyl chloride-based resin composition used in the present invention may be used as a powder compound that is mixed by using a conventionally known mixer, for example, a Henschel mixer, a super mixer, a ribbon blender and the like, or a pellet compound that is obtained by melting and mixing the powder compound. The powder compound can be manufactured under a conventionally known general condition, and it may be hot blending or cold blending. Particularly preferably, in order to reduce a volatile component in the composition, the hot blending in which a cut temperature is increased to 105° C. to 155° C. at the time of the blending is used.

The pellet compound can be manufactured similarly to a method for manufacturing a general vinyl chloride-based pellet compound. For example, by using a kneader such as a monoaxial extruder, a different direction biaxial extruder, a conical biaxial extruder, a same direction biaxial extruder, a Ko-kneader, a planetary gear extruder and a roll kneader, the pellet compound can be manufactured. A condition for manufacturing the pellet compound is not limited particularly, but it is particularly preferable to set a resin temperature to be 185° C. or less.

Moreover, in order to remove a foreign matter such as a metal piece of a cleaning tool, which can be mixed in the pellet compound, it is possible to adopt various methods such as providing a fine-meshed stainless mesh or the like with 200 meshes or less in the kneader, adopting a means for removing “cuttings” and the like that may be mixed at the time of cold cutting, and carrying out the hot cutting, but it is particularly preferable to carry out the hot cutting method in which less “cuttings” are mixed.

In the present invention, when processing the vinyl chloride-based resin composition into an undrawn filament in a fiber state, a conventionally known extruder and the like can be used. For example, a monoaxial extruder, a different direction biaxial extruder, a conical biaxial extruder and the like can be used, but a monoaxial extruder with a bore ranging, for example, from about 30 mmφ to about 60 mmφ or a conical extruder with a bore ranging from about 35 mmφ to about 50 mmφ preferably is used. If the bore is too large, an amount of extrusion is too large, the nozzle pressure is excessively high, and an outflowing speed of the undrawn filament is too high, by which the winding tends to be difficult, thus being not preferable.

In the present invention, the nozzle pressure when carrying out the melt spinning preferably is 500 kg/cm² or less. If the nozzle pressure is more than 500 kg/cm², a malfunction is likely to be caused at a thrust section of the extruder, and “resin leakage” is likely to be caused from a connecting portion of a turn head, a die and the like, thus being not preferable. The nozzle pressure can be decreased by increasing the resin temperature, but it is preferable to carry out the spinning at the resin temperature of 195° C. or less, as the temperature condition at the time of the melt spinning. If the spinning is carried out under the condition at the resin temperature of more than 195° C., the coloration trend of the fiber becomes significant, and the color of the fiber becomes strong yellow, thus being not preferable. Thus, it is particularly preferable that a cylinder temperature of the extruder ranges from about 140° C. to about 185° C., and the temperature of the die and the nozzle ranges from about 160° C. to about 190° C.

In the present invention, it is possible to carry out the melt spinning by using a conventionally known nozzle, but a nozzle with nozzle holes, each of which has a cross-sectional area of 0.5 mm² or less, is preferably attached to a die tip portion, considering the property such as a touch feeling. If using the nozzle having the cross-sectional area of more than 0.5 mm², it becomes necessary to sufficiently melt the compound at a high temperature, extrude it and draw it with a high spinning draft, in order to obtain an undrawn filament with a desired fineness. Then, a surface of the fiber becomes too smooth and has a smooth touch feeling like a plastic, and a dry touch feeling like human hair cannot be obtained, thus being not preferable. It is preferable to draw an undrawn filament with a fineness of 300 dtexes or less by using the nozzle with the nozzle holes, each of which has the cross-sectional area of 0.5 mm² or less. If the fineness of the undrawn filament is more than 300 dtexes, a drawing ratio is required to be increased at the time of the drawing treatment, in order to obtain the fiber with the small fineness. Thus, the surface of the fiber becomes too smooth and has a touch feeling that is smooth like a plastic, and a dry touch feeling like human hair cannot be obtained, which is not preferable.

The undrawn filament that is obtained by the melt spinning is subjected to drawing treatment and heat treatment by a known method, and can be processed into a fiber with a small fineness of 100 dtexes or less. As a fiber for hair adornment, the fineness particularly preferably ranges from 25 dtexes to 100 dtexes. If the fineness is more than 100 dtexes, the touch feeling becomes unyielding, and a soft touch feeling like human hair is difficult to be obtained. Moreover, as a fiber for doll hair, the fineness particularly preferably ranges from 10 dtexes to 65 dtexes. As a condition of the drawing treatment, it is particularly preferable to draw at a drawing ratio ranging from about 200% to about 450% in the atmosphere at drawing treatment temperature ranging from 70° C. to 150° C. If the drawing treatment temperature is less than 70° C., a strength of the fiber is decreased, and filament breakage is likely to occur, on the other hand, if the drawing treatment temperature is more that 150° C., the touch feeling of the fiber becomes a smooth touch feeling like a plastic, and the filament breakage also tends to occur, thus being not preferable. Moreover, if the drawing ratio is less than 200%, occurrence of the strength of the fiber is likely to be insufficient, and if the drawing ratio is more than 450%, the filament breakage is likely to occur at the time of the drawing treatment, thus being not preferable.

Moreover, the fiber that is subjected to the drawing treatment is further subjected to heat treatment, and is subjected to releasing treatment at a releasing ratio ranging from 2% to 40%, thereby decreasing the heat shrinkage ratio. Also, in order to smooth asperities on the surface of the fiber and obtain a dry touch feeling that is similar to human hair, the releasing treatment is preferable. If the releasing ratio is out of the above-described range, the quality as a fiber for artificial hair or doll hair such as the filament strength tends to deteriorate, thus being not preferable. The heat treatment can be carried out together with the drawing treatment, and also can be carried out separately. As a temperature condition of the heat treatment, the heat treatment is particularly preferably carried out in the atmosphere at an atmospheric temperature ranging from 80° C. to 150° C. Further, in the present invention, conventionally known techniques relating to the melt spinning, for example, various techniques relating to a cross-sectional shape of the nozzle, techniques relating to a heated chimney, techniques relating to the drawing treatment and the like can be used in combination freely.

### EXAMPLE

Examples will be described below so as to explain specific embodiments of the present invention in further detail, but the present invention is not limited only to these examples.

About 7 kg of each blended resin obtained by blending, with respect to 100 parts by weight of a vinyl chloride resin, a hydrotalcite-based thermostabilizer, a calcium soap/a zinc soap, β-diketone, a lubricant and a plasticizer as appropriate, according to blend examples shown in Table 1, was poured into a 20 L Henschel mixer, and was stirred and mixed until a temperature of the materials was increased to 120° C., subsequently was cooled down until the temperature of the materials was decreased to 60° C., thereby manufacturing a vinyl chloride-based resin compound in a state of powder.

TABLE 1

| | Example/Comparative Example | | | | | |
|---|---|---|---|---|---|---|
| | Example 1 | Example 2 | Example 3 | Example 4 | Example 5 | Example 6 |
| vinyl chloride resin (*1) | 100 | 100 | 100 | 100 | 100 | 100 |
| ALCAMIZER 1 (*2) | 0.1 | 0.1 | 0.1 | 0.1 | 0.2 | 0.3 |
| β-diketone SBM | 0.05 | 0.2 | 0.25 | 0.1 | 0.1 | 0.2 |
| β-diketone DBM | 0.05 | 0.2 | 0.24 | 0.1 | 0.1 | 0.2 |
| calcium soap, | 0.2 | 0.3 | 0.5 | 0.4 | 0.4 | 0.3 |
| zinc soap | | | | | | |
| (mixed at weight | | | | | | |
| ratio of 1:1) | | | | | | |
| lubricant (*3) | 0.7 | 1.7 | 1.7 | 0.7 | 1.3 | 1.3 |
| plasticizer (*4) | 0.5 | 5.0 | 1.0 | 4.0 | 4.0 | 2.0 |
| transparency | B | B | B | A | A | A |
| colorability | C | B | B | C | B | A |
| condition of | A | A | A | A | A | A |
| occurrence of | | | | | | |
| filament breakage | | | | | | |
| during spinning | | | | | | |
| condition of | A | A | A | A | A | A |
| generation of | | | | | | |
| deteriorated resin | | | | | | |
| during spinning | | | | | | |

Example/Comparative Example

| | Example 7 | Example 8 | Example 9 | Example 10 | Example 11 |
|---|---|---|---|---|---|
| vinyl chloride resin (*1) | 100 | 100 | 100 | 100 | 100 |
| ALCAMIZER 1 (*2) | 0.2 | 0.5 | 0.6 | 0.6 | 0.6 |
| β-diketone SBM | 0.15 | 0.1 | 0.05 | 0.25 | 0.25 |
| β-diketone DBM | 0.15 | 0.1 | 0.05 | 0.25 | 0.25 |
| calcium soap, | 0.4 | 0.4 | 0.5 | 0.3 | 0.5 |
| zinc soap | | | | | |
| (mixed at weight | | | | | |
| ratio of 1:1) | | | | | |
| lubricant (*3) | 1.0 | 1.3 | 1.7 | 0.7 | 1.7 |
| plasticizer (*4) | 3.0 | 4.0 | 1.0 | 5.0 | 5.0 |
| transparency | A | B | B | B | B |
| colorability | A | A | B | B | B |
| condition of | A | A | A | A | A |
| occurrence of | | | | | |
| filament breakage | | | | | |
| during spinning | | | | | |
| condition of | A | A | B | A | B |
| generation of | | | | | |
| deteriorated resin | | | | | |
| during spinning | | | | | |

(*1) Kanevinyl S1001 (viscosity average degree of polymerization: about 1020): produced by Kaneka Corporation
(*2) ALCAMIZER 1: hydrotalcite-based thermostabilizer produced by Kyowa Chemical Industry Co., Ltd.
(*3) REKEMAL TG-12: produced by Riken Vitamin Co., Ltd./Loxiol G70: produced by Cognis Japan Ltd./Rikestar EW100: produced by Riken Vitamin Co., Ltd/Hi-wax 4202E: produced by Mitsui Chemicals, Inc./stearic acid: produced by NOF CORPORATION = 6/3/1/1/2 mixed material
(*4) plasticizer: trioctyltrimellitate (TOTM)/epoxidized soybean oil (ESBO) = 1/1 mixed material

As shown in Table 1, in each of the blend examples of Examples 1 to 11 where added amounts of hydrotalcite (“ALCAMIZER 1” as product name) ranged from 0.1 parts by weight to 0.6 parts by weight, there occurred no problem in coloration at the time of the melt spinning, and the transparency was improved, a luster of the spinned filament was improved, and the stable spinning can be carried out without generating a deteriorated resin at the nozzle portion at the time of the spinning. Moreover, the filament that caused almost no breakage by the drawing treatment and the heat treatment could be obtained.

In contrast to Examples, experiments were carried out in the conditions where added amounts of hydrotalcite (“ALCAMIZER 1” as product name) ranged from 0.0 part to 0.7 parts by weight, as Comparative Examples 1 to 8 shown in Table 2. As a result, in the case of Comparative Example 1 where the added amount of ALCAMIZER 1 was 0 part, a deteriorated resin was generated at the time of the spinning, and the filament breakage occurred frequently. This was assumed to be caused by the generation of a large amount of the lustrous black deteriorated resin, which was assumed to be generated by thermal decomposition of the vinyl chloride resin. In Comparative Example 2, since 0 part of β-diketone was used, there occurred a problem in the colorability and the like, and the filament breakage was increased. In Comparative Example 3, since the calcium soap and the zinc soap were insufficient, the occurrence of the filament breakage was increased. In Comparative Example 4, because the added amount of the lubricant was decreased, the colorability deteriorated, and the filament breakage was increased. In Comparative Example 5, because of 0 part of β-diketone, the colorability deteriorated. In Comparative Example 6, due to the increase of the added amount of hydrotalcite, the transparency was decreased. In Comparative Example 7, due to the increase of the added amount of hydrotalcite, the occurrence of the filament breakage was increased. In Comparative Example 8, as a result of further increase of hydrotalcite, the transparency was decreased, and the generation of the deteriorated resin was increased.

TABLE 2

| | Example/Comparative Example | | | | | | | |
|---|---|---|---|---|---|---|---|---|
| | Comparative | Comparative | Comparative | Comparative | Comparative | Comparative | Comparative | Comparative |
| | Example 1 | Example 2 | Example 3 | Example 4 | Example 5 | Example 6 | Example 7 | Example 8 |
| vinyl chloride resin (*1) | 100 | 100 | 100 | 100 | 100 | 100 | 100 | 100 |
| ALCAMIZER 1 (*2) | 0 | 0.1 | 0.2 | 0.3 | 0.5 | 0.7 | 0.7 | 1.5 |
| β-diketone SBM | 0.05 | 0 | 0.1 | 0.15 | 0 | 0.05 | 0.25 | 0 |
| β-diketone DBM | 0.05 | 0 | 0.1 | 0.15 | 0 | 0.05 | 0.25 | 0.2 |
| calcium soap, | 0.2 | 0.5 | 0.1 | 0.4 | 0.4 | 0.5 | 0.5 | 0.5 |
| zinc soap | | | | | | | | |
| (mixed at weight ratio of 1:1) | | | | | | | | |
| lubricant (*3) | 0.7 | 1.7 | 1.3 | 0.6 | 1.3 | 1.7 | 1.7 | 0.8 |
| plasticizer (*4) | 0.5 | 1.0 | 4.0 | 3.0 | 4.0 | 1.0 | 5.0 | 1.0 |
| transparency | C | B | B | B | B | C | B | C |
| colorability | D | D | C | C | C | B | B | B |
| condition of occurrence of | B | B | C | C | A | A | B | A |
| filament breakage during | | | | | | | | |
| spinning | | | | | | | | |
| condition of generation of | C | B | B | B | B | B | B | B |
| deteriorated resin during | | | | | | | | |
| spinning | | | | | | | | |

(*1) Kanevinyl S1001 (viscosity average degree of polymerization: about 1020): produced by Kaneka Corporation
(*2) ALCAMIZER 1: hydrotalcite-based thermostabilizer produced by Kyowa Chemical Industry Co., Ltd.
(*3) REKEMAL TG-12: produced by Riken Vitamin Co., Ltd./Loxiol G70: produced by Cognis Japan Ltd./Rikestar EW100: produced by Riken Vitamin Co., Ltd/Hi-wax 4202E: produced by Mitsui Chemicals, Inc./stearic acid: produced by NOF CORPORATION = 6/3/1/1/2 mixed material
(*4) plasticizer: trioctyltrimellitate (TOTM)/epoxidized soybean oil (ESBO) = 1/1 mixed material

[Evaluation of Transparency of Resin]

400 g of the vinyl chloride-based resin compound in the state of powder that was manufactured as shown in Tables 1 and 2 was kneaded and melted at 185° C. for 5 minutes by a 8-inch roll, and was subjected to heat pressing at 195° C. for 7 minutes so as to manufacture a sheet with a thickness of 1 mm, and a haze value thereof was measured by using a hazemeter NDH2000 produced by Nippon Denshoku Industries Co., Ltd.

The transparency is represented according to the haze value as follows.

A: haze value was 16 or less

B: haze value was more than 16 and less than 17

C: haze value was 17 or more

[Evaluation of Colorability of Resin]

The vinyl chloride-based resin compound in the state of powder that was manufactured as shown in Tables 1 and 2 was kneaded for 5 minutes under a condition including: a jacket temperature of 185° C.; the rotor winding number of 50 rpm; and an sample charge amount of 65 g, by using a Labo Plastomill (a kneader type) produced by TOYO SEIKI KOGYO CO., LTD., and the sample was taken out so that the colorability thereof was evaluated visually.

A: color was not changed at all

B: color was slightly changed to yellow

C: color was changed to pale yellow

D: color was changed to yellow

By using the vinyl chloride-based resin compound in the state of powder that was manufactured as shown in Tables 1 and 2, melt spinning experiments were carried out under conditions shown in Table 3.

TABLE 3

| | |
|---|---|
| extruder screw nozzle | 40 mmΦ, monoaxial extruder, L/D = 25 |
| | full flight type, compression ratio = 2.5 |
| | hole cross-sectional area = 0.064 mm² |
| | number of holes = 120 |
| cylinder temperature | C1 = 140° C., C2 = 170° C. |
| | C3 = 184° C., C4 = 180° C. |
| adapter temperature | AD = 175° C. |
| turn head temperature | TH = 180° C. |
| nozzle temperature | NH = 180° C. |
| heated spinning chimney | HT310° C. atmospheric temperature |
| temperature | |

In the melt spinning experiment, after being in a steady state, a relationship between the screw winding number and the amount of extrusion was obtained, and the screw winding number was determined such that the amount of extrusion was 7.5 kg/hr. A die pressure gauge was disposed at an adapter portion so as to achieve measurement. A strand that was melted and flowed out from the nozzle in a vertical direction was introduced into the heated spinning chimney, where the strand was heated and melted instantly, and an undrawn filament was wound at a certain speed by a receiver disposed in a position that was directly beneath the nozzle by about 3 m. At this time, the receiving speed was adjusted such that the undrawn filament was about 168 dtexes. In the step of manufacturing this undrawn filament, a condition of the occurrence of the filament breakage and a condition of the generation of the deteriorated resin were observed visually, and were evaluated as follows. Subsequently, the undrawn filament was passed through a hot-air drawing box at 110° C. so as to be drawn by 3.8 times. Further, it was subjected to releasing treatment of 35% in the box at an adjusted temperature of 110° C., thereby manufacturing a multifilament with a unifilar filament fineness of 72 dtexes.

[Condition of Occurrence of Filament Breakage During Melt Spinning]

A: filament breakage did not occur at all

B: filament breakage occurred five times or less in one hour

C: filament breakage occurred six times to fifteen times in one hour

[Condition of Generation of Deteriorated Resin During Melt Spinning]

The deteriorated resin generated at the tip of the nozzle after 3 hours from the start of the spinning was judged visually.

A: deteriorated resin was not generated at all

B: small amount of deteriorated resin was generated in one to five holes

C: deteriorated resin was generated in all holes

1. A polyvinyl chloride-based fiber that is formed of a vinyl chloride-based resin composition comprising, with respect to (a) 100 parts by weight of a vinyl chloride-based resin, (b) 0.1 parts by weight to 0.6 parts by weight of a hydrotalcite-based thermostabilizer, (c) 0.1 parts by weight to 0.5 parts by weight of β-diketone, (d) 0.2 parts by weight to 0.5 parts by weight of a calcium soap and a zinc soap, (e) 0.7 parts by weight to 1.7 parts by weight of a lubricant, and (f) 0.5 parts by weight to 5 parts by weight of a plasticizer.

2. The polyvinyl chloride-based fiber according to claim 1, wherein the β-diketone that is the component (c) is at least one selected from stearoylbenzoylmethane (SBM) and dibenzoylmethane (DBM).

3. The polyvinyl chloride-based fiber according to claim 1, wherein the calcium soap and the zinc soap that are the component (d) at least one selected from a calcium salt of higher fatty acid a zinc salt of higher fatty acid and derivatives of them.

4. The polyvinyl chloride-based fiber according to claim 1, wherein the lubricant that is the component (e) is at least one selected from the group consisting of: a polyethylene-based lubricant; a higher fatty acid-based lubricant; a higher alcohol-based lubricant; and an ester-based lubricant.

5. The polyvinyl chloride-based fiber according to claim 1, wherein the plasticizer that is the component (f) is at least one selected from the group consisting of: a phthalate-based plasticizer; a trimellitate-based plasticizer; a pyromellitate-based plasticizer; a polyester-based plasticizer; and an epoxy-based plasticizer.

6. The polyvinyl chloride-based fiber according to claim 1, wherein the hydrotalcite-based thermostabilizer that is the component (b) within a range from 0.2 parts by weight to 0.5 parts by weight, the lubricant that is the component (e) within a range from 0.7 parts by weight to 1.3 parts by weight, and the plasticizer that is the component (f) ranges from 1 part by weight to 4 parts by weight are blended.

7. (canceled)

8. The polyvinyl chloride-based fiber according to claim 1, wherein the vinyl chloride-based resin that is the component (a) is a homopolymer resin of vinyl chloride, or a copolymer resin with a monomer that can be copolymerized with vinyl chloride.

9. The polyvinyl chloride-based fiber according to claim 8, wherein the copolymer resin is at least one selected from: a copolymer resin of vinyl chloride and vinyl ester; a copolymer resin of vinyl chloride and acrylic ester; a copolymer resin of vinyl chloride and olefin; and a copolymer resin of vinyl chloride and acrylonitrile.

10. The polyvinyl chloride-based fiber according to claim 8, wherein a content of the monomer that can be copolymerized with vinyl chloride in the copolymer resin ranges from 2 wt % to 30 wt %.

11. The polyvinyl chloride-based fiber according to claim 1, wherein a viscosity average degree of polymerization of the vinyl chloride-based resin that is the composition (a) ranges from 850 to 1700.

12. A method for manufacturing a polyvinyl chloride-based fiber, wherein, when carrying out melt spinning with respect to the vinyl chloride-based resin composition comprising, with respect to (a) 100 parts by weight of a vinyl chloride-based resin, (b) 0.1 parts by weight to 0.6 parts by weight of a hydrotalcite-based thermostabilizer, (c) 0.1 parts by weight to 0.5 parts by weight of β-diketone, (d) 0.2 parts by weight to 0.5 parts by weight of a calcium soap and a zinc soap, (e) 0.7 parts by weight to 1.7 parts by weight of a lubricant, and (f) 0.5 parts by weight to 5 parts by weight of a plasticizer, the vinyl chloride-based resin composition is subjected to melt spinning from nozzle holes, each of which has a cross-sectional area of 0.5 mm² or less, an undrawn filament of 300 dtexes or less is manufactured, and subsequently the undrawn filament is subjected to drawing treatment and heat treatment so as to process into a fiber of 100 dtexes or less.

13. The method for manufacturing a polyvinyl chloride-based fiber according to claim 12, wherein the β-diketone that is the component (c) is at least one selected from stearoylbenzoylmethane (SBM) and dibenzoylmethane (DBM).

14. The method for manufacturing a polyvinyl chloride-based fiber according to claim 12, wherein the calcium soap and the zinc soap that are the component (d) are at least one selected from higher fatty acid calcium, higher fatty acid zinc and derivatives of them.

15. The method for manufacturing a polyvinyl chloride-based fiber according to claim 12, wherein the lubricant that is the component (e) is at least one selected from the group consisting of: a polyethylene-based lubricant; a higher fatty acid-based lubricant; a higher alcohol-based lubricant; and an ester-based lubricant.

16. The method for manufacturing a polyvinyl chloride-based fiber according to claim 12, wherein the plasticizer that is the component (f) is at least one selected from the group consisting of: a phthalate-based plasticizer; a trimellitate-based plasticizer; a pyromellitate-based plasticizer; a polyester-based plasticizer; and an epoxy-based plasticizer.

17. The method for manufacturing a polyvinyl chloride-based fiber according to claim 12, wherein the hydrotalcite-based thermostabilizer that is the component (b) within a range from 0.2 parts by weight to 0.5 parts by weight, the lubricant that is the component (e) within a range from 0.7 parts by weight to 1.3 parts by weight, and the plasticizer that is the component (f) within a range from 1 part by weight to 4 parts by weight are blended.

18. The method for manufacturing a polyvinyl chloride-based fiber according to claim 12, wherein the vinyl chloride-based resin that is the component (a) is a homopolymer resin of vinyl chloride, or a copolymer resin with a monomer that can be copolymerized with vinyl chloride.

19. The method for manufacturing a polyvinyl chloride-based fiber according to claim 18, wherein the copolymer resin is at least one selected from: a copolymer resin of vinyl chloride and vinyl ester; a copolymer resin of vinyl chloride and acrylic ester; a copolymer resin of vinyl chloride and olefin; and a copolymer resin of vinyl chloride and acrylonitrile.

20. The method for manufacturing a polyvinyl chloride-based fiber according to claim 18, wherein a content of the monomer that can be copolymerized with vinyl chloride in the copolymer resin ranges from 2 wt % to 30 wt %.

21. The method for manufacturing a polyvinyl chloride-based fiber according to claim 12, wherein a viscosity average degree of polymerization of the vinyl chloride-based resin that is the composition (a) ranges from 850 to 1700.
